(19) United States
(12) Patent Application Publication
(10) Pub. No.: US 2026/0117751 A1
(43) Pub. Date: Apr. 30, 2026

(54) ACTUATOR ASSEMBLY

(71) Applicant: CAMBRIDGE MECHATRONICS LIMITED, Cambridge (GB)

(72) Inventors: Oliver Hart, Cambridge (GB); Andrew Lam, Cambridge (GB); Samuel Amstrong, Cambridge (GB); Nicholas Heijne, Cambridge (GB); Andrew Benjamin Simpson Brown, Cambridge (GB)

(21) Appl. No.: 19/117,168

(22) PCT Filed: Oct. 6, 2023
(86) PCT No.: PCT/GB2023/052596

§ 371 Date: Mar. 31, 2025

(30) Foreign Application Priority Data
Oct. 6, 2022 (GB) 2214699.7

(51) Int. Cl. F03G 1/10; F03G 7/06; F16C 19/16; G03B 13/34

(52) U.S. Cl. CPC F03G 1/10; F03G 7/0665; F16C 19/16; G03B 13/34; F03G 7/06143

(57) ABSTRACT

An actuator assembly (1) comprising: a support structure (2); a movable part (10); a helical bearing arrangement (20) arranged to guide helical movement of the movable part relative to the support structure around a helical axis (H); a loading arrangement (50) arranged between the support structure and the movable part for loading the helical bearing arrangement; and at least one pair of actuator components (40) arranged, on actuation, to drive rotation of the movable part in opposite senses around the helical axis which the helical bearing arrangement converts into said helical movement; wherein the at least one pair of actuator components is arranged to apply an unloading torque about an axis perpendicular to the helical axis so as to reduce loading of the helical bearing arrangement.

### FIELD

The present application relates to an actuator assembly.

### BACKGROUND

It is known to use an actuator, for example a shape memory alloy, SMA, element, to drive translational movement of a movable element with respect to a support structure. SMA have particular advantages in miniature devices and may be applied in a variety of devices including handheld devices, such as cameras and mobile phones. Such SMA elements may be used for example in an optical device such as a camera for driving translational movement of a camera lens element along its optical axis, for example to effect focussing (autofocus, AF) or zoom.

Some examples of an SMA actuation apparatuses which are cameras of this type are disclosed in WO 2007/113478 A1. Herein, the movable element is a camera lens element supported on a support structure by a helical bearing arrangement comprising flexures that guide translational movement along the optical axis. In one example described herein, the SMA element is a piece of SMA wire connected at its ends to a support structure and hooked over a hook on a camera lens element for driving the translational movement. The straight SMA wires formed by the portions of the piece of SMA wire on either side of the hook extend at an acute angle of greater than 0 degrees to the movement direction parallel to the optical axis. Angling the SMA wires in this way increases the amount of movement compared to an SMA wire extending along the movement direction and also reduces the extent of the actuator in the movement direction.

WO 2019/243849 A1 discloses an SMA apparatus comprising a helical bearing arrangement that converts rotation around a helical axis into a helical movement.

The helical bearing arrangement is loaded in use, i.e. the bearing surfaces are urged towards each other. It is desirable to reduce the possibility of loading force directly affecting the helical movement in addition to loading the helical bearing arrangement. It is also desirable to reduce the power and/or energy required to control the helical movement and/or position.

### SUMMARY

According to an aspect of the present invention, there is provided an actuator assembly comprising: a support structure; a movable part; a helical bearing arrangement arranged to guide helical movement of the movable part relative to the support structure around a helical axis; a loading arrangement arranged between the support structure and the movable part for loading the helical bearing arrangement; and at least one pair of actuator components arranged, on actuation, to drive rotation of the movable part in opposite senses around the helical axis which the helical bearing arrangement converts into said helical movement; wherein the at least one pair of actuator components is arranged to apply an unloading torque about an axis perpendicular to the helical axis so as to reduce loading of the helical bearing arrangement.

By applying the unloading torque, the load on the helical bearing arrangement can be controlled. As one example, this allows the load to be made lower when movement of the movable part is desired and made higher when movement is not desired. By applying the unloading torque with the actuator components, the number of parts may be minimised.

Optionally, the loading arrangement is arranged to apply a loading torque about an axis perpendicular to the helical axis for loading the helical bearing arrangement.

By applying the loading torque perpendicular to the helical axis, the lateral forces imposed by the loading arrangement may be reduced. This can help to increase the accuracy of control of the position of the movable part.

Optionally, the at least one pair of actuator components are arranged to apply forces to the movable part relative to the support structure that are offset from each other along the helical axis.

By offsetting the forces, a torque can be generated by the actuator components. This can help to provide the unloading function without unduly generating unwanted forces that may affect the movement of the movable part.

Optionally, the at least one pair of actuator components are arranged to apply forces in opposite directions perpendicular to the helical axis such that the unloading torque can be applied without applying an overall force perpendicular to the helical axis.

By providing the forces in opposite directions, the total force applied perpendicular to the helical axis may be reduced. This can help to improve the accuracy of control of the movable part, particularly towards the extremes of the stroke.

Optionally, the helical bearing arrangement is arranged to have sufficient friction when loaded that the movable part remains in position, when the actuator components are not applying an unloading torque and/or when the actuator components are not driving rotation of the movable part. Optionally, the helical bearing arrangement is arranged to have sufficient friction when loaded that the movable part, over a continuum of positions, remains in position, when the actuator components are not applying an unloading torque and/or when the actuator components are not driving rotation of the movable part. The frictional forces in the helical bearing arrangement, when the actuator components are not applying an unloading torque, may be greater than the weight of the movable part (optionally including a lens assembly when such a lens assembly is fixed relative to the movable part). The frictional forces in the helical bearing arrangement, when the actuator components are not applying an unloading torque, may be greater than 1.5 times, or 2 times, the weight of the movable part (optionally including a lens assembly when such a lens assembly is fixed relative to the movable part).

By providing sufficient friction, the power and/or energy requirements to maintain the position of the movable part may be reduced. By providing sufficient friction, the power and/or energy requirements to maintain an arbitrary position of the movable part within a range of movement of the movable part may be reduced. The movable part may be held in position by the frictional forces in the helical bearing arrangement, without powering the actuator components.

Optionally, the pair of actuator components is arranged, on actuation, to apply the unloading torque so as to reduce the frictional forces in the helical bearing arrangement.

By applying the unloading torque, the motion of the movable part can be made easier when required. This can help to reduce the possibility of the movable part undesirably sticking. The force required to move the movable part along the helical axis may be reduced compared to a situation in which the frictional forces are not reduced by the unloading torque.

Optionally, the helical bearing arrangement comprises at least one helical bearing that is a rolling bearing comprising bearing surfaces on the support structure and the moveable element and at least one rolling bearing element disposed between the bearing surfaces.

By providing a rolling bearing the ease of movement of the movable part may be increased.

Optionally, wherein the helical bearing arrangement comprises at least one helical bearing that is a sliding bearing comprising bearing surfaces on the support structure and the moveable part arranged to slide against each other. The sliding bearing may provide the frictional forces in the helical bearing arrangement.

By providing a sliding bearing, the friction may be increased so that it is easier for the position of the movable part to be maintained with reduced power/energy requirements.

Optionally, the helical bearing arrangement comprises three helical bearings.

By providing three helical bearings, the movement of the movable part may be more reliably constrained to movement along the helical axis.

Optionally, the bearing surfaces of first and second helical bearings each comprises grooves on each of the support structure and the movable part, and the bearing surfaces of a third helical bearing comprises a groove on one of the support structure and the movable part and a planar surface on the other of the support structure and the movable part.

By providing grooves, the helical bearing may constrain movement of the movable part in two degrees of freedom. This may reduce the number of helical bearings required. The three helical bearings may thus allow only a single degree of freedom of movement of the movable part relative to the support structure, in particular only movement along a helical path.

Optionally, the first, second and third helical bearings each comprise a single rolling bearing element only.

By providing rolling bearings the ease of movement of the movable part may be increased.

Optionally, the at least one pair of actuator components is arranged to reduce loading of the helical bearing arrangement by less than loading applied by loading arrangement.

By providing that the unloading is less than the loading, the helical bearing arrangement can remain loaded during use of the actuator assembly.

According to another aspect of the present invention, there is provided an actuator assembly comprising: a support structure; a movable part; a helical bearing arrangement arranged to guide helical movement of the movable part relative to the support structure around a helical axis; at least one actuator component arranged, on contraction, to drive rotation of the movable part around the helical axis which the helical bearing arrangement converts into said helical movement; and a loading arrangement arranged to apply a loading torque about an axis perpendicular to the helical axis for loading the helical bearing arrangement.

By applying the loading torque perpendicular to the helical axis, the lateral forces imposed by the loading arrangement may be reduced. This can help to increase the accuracy of control of the position of the movable part.

Optionally, the loading arrangement comprises a resilient loading arrangement for resiliently loading the helical bearing arrangement.

By providing a resilient loading arrangement, the loading may be provided without increasing power requirements.

Optionally, the resilient loading arrangement comprises a pair of resilient elements connected between the support structure and the movable part.

By providing a pair of resilient elements, the forces applied may at least partly cancel each other out in directions other than the desired rotational direction for the loading torque.

Optionally, the resilient loading arrangement comprises at least one resilient element (optionally the pair of resilient elements) between the support structure and the movable part, the or each resilient element comprising at least a portion extending between the support structure and the movable part that is at least as thick in a direction parallel to the helical axis as in a direction perpendicular to the helical axis. So, the portion extending between the support structure and the movable part may be thicker in a direction parallel to the helical axis than in a direction perpendicular to the helical axis. The extent of the portion in the direction parallel to the helical axis may be greater than the extent of the portion in a direction perpendicular to the helical axis.

By providing a resilient element with greater extent in the direction parallel to the helical axis, the lateral forces acting on the movable part may be reduced or minimised. This can help to increase the accuracy of control of the position of the movable part.

Optionally, the resilient loading arrangement comprises at least one resilient element (optionally the pair of resilient elements) between the support structure and the movable part, wherein the or each resilient element is stressed in its mounted position connected between the support structure and the movable part so as to load the helical bearing arrangement, whereby parts of the or each resilient element that engage with the support structure and the movable part are less distanced in a direction along the helical axis than if the resilient element were not stressed. So, the at least one resilient element may be pre-loaded by a pre-load force acting in a direction along the helical axis.

By providing a stressed resilient element, the loading torque may be applied in a mechanically simple way that is relatively easy to manufacture.

Optionally, the difference in how distanced along the helical axis the parts of the resilient element that engage with the support structure and the movable part is greater than a possible range of movement of the movable part along the helical axis. So, the resilient element may be pre-loaded across the entire possible range of movement of the movable part along the helical axis.

By providing a greater preload distance, it can be ensured that the loading arrangement applies a loading force over the entire possible range of movement. The helical bearing arrangement can thus reliably be held together by the loading arrangement at any position along the range of movement. This can help to increase the accuracy of control of the position of the movable part.

Optionally, the resilient loading arrangement comprises at least one resilient element (optionally the pair of resilient elements) between the support structure and the movable part, the or each resilient element being stiffer to bending around an axis perpendicular to the helical axis than to bending around the helical axis.

By providing stiffness to bending perpendicular to the helical axis, lateral forces applied may be reduced or minimised. This can help to increase the accuracy of control of the position of the movable part.

Optionally, the resilient loading arrangement comprises at least one resilient element (optionally each of the pair of resilient elements) that engages with at least one of the support structure and the movable part via a bearing arrangement. The bearing arrangement may allow movement of the resilient element relative to the support structure or movable part in a direction perpendicular to the helical axis.

By providing a bearing arrangement, the effect of lateral forces on the support structure or movable part may be reduced. This can help to increase the accuracy of control of the position of the movable part.

Optionally, the loading arrangement comprises a magnetic loading arrangement.

By providing a magnetic arrangement, the lateral forces on the movable part may be reduced. This can help to increase the accuracy of control of the position of the movable part.

Optionally, each actuator component is a shape memory alloy, SMA, element. The SMA element may also be referred to as an SMA wire.

By providing an SMA element, the actuation may be effected particularly accurately and simply. SMA, due to its high energy density, may also provide for a particularly compact actuator component, allowing the actuator assembly to be used in miniature applications, such as miniature cameras.

Optionally, the movable part comprises a lens assembly having at least one lens, wherein the helical axis is parallel to or coincides with the optical axis of the lens assembly.

By providing a lens assembly, the control of the position of the movable part may be implemented in the context of an optical focusing system or optical athermilization system, for example.

Optionally, the support structure has an image sensor mounted thereon, the lens assembly being arranged to focus an image on the image sensor.

By providing an image sensor, the actuator assembly may be implemented as a camera, for example.

### BRIEF DESCRIPTION OF THE DRAWINGS

Certain embodiments of the present invention will now be described, by way of example only, with reference to the accompanying drawings in which:

FIG. 1 is a schematic view of an actuator assembly with a helical bearing arrangement;

FIG. 2 is a schematic view of an actuator assembly with a loading arrangement;

FIG. 3 is a schematic side view of the actuator assembly shown in FIG. 2;

FIG. 4 is a schematic view of a sliding bearing;

FIG. 5 is a different schematic view of the sliding bearing shown in FIG. 4;

FIG. 6 is a schematic view of a sliding bearing;

FIG. 7 is a different schematic view of the sliding bearing shown in FIG. 6;

FIG. 8 is a schematic view of a rolling bearing;

FIG. 9 is a schematic view of a rolling bearing;

FIG. 10 is a schematic view of a possible helical bearing arrangement;

FIG. 11 is a schematic view of part of a loading arrangement;

FIG. 12 is a schematic view of part of a loading arrangement;

FIG. 13 is a schematic plan view of part of a loading arrangement;

FIG. 14 is a schematic side view of an actuator assembly;

FIG. 15 is a schematic side view of an actuator assembly;

FIG. 16 is a schematic side view of an actuator assembly; and

FIG. 17 is a schematic side view of an actuator assembly.

### DETAILED DESCRIPTION

### Actuator Assembly

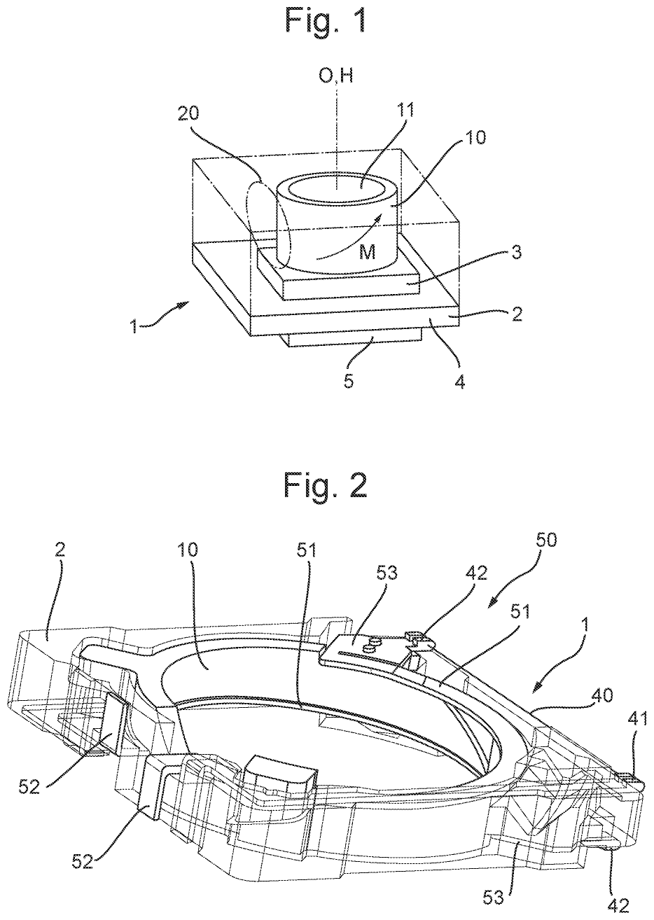

An actuator assembly 1 is shown schematically in FIG. 1. The actuator assembly 1 may be a camera. The actuator assembly 1 is described primarily in the context of the actuator assembly 1 being a camera. However, the actuator assembly 1 is not required to be a camera and may be embodied as a different type of apparatus.

The actuator assembly 1 comprises a support structure 2. The support structure 2 may have one or more components fixed to it, for example mounted onto it. For example, when the actuator assembly 1 is a camera, the support structure 2 may have an image sensor 3 mounted thereon. The support structure 2 may take any suitable form, typically including a base 4 to which the image sensor is fixed. The support structure 2 may also support an IC chip 5.

The actuator assembly 1 also comprises a movable part 10 (or movable element). Optionally the movable part 10 is or comprises a lens assembly 11 having one or more lenses. The movable part 10 has an axis O (for example an optical axis) aligned with the image sensor 3 and may be arranged to focus an image on the image sensor 3.

The actuator assembly 1 may be a miniature device. In some examples of a miniature device, the lens (or plural lenses, when provided) of the lens assembly 11 may have a diameter of at most 20 mm, preferably at most 15 mm, preferably at most 10 mm.

Although the actuator assembly 1 in this example is a camera, that is not in general essential. In some examples, the actuator assembly 1 may be an optical device in which the movable part 10 comprises a lens assembly 11 but there is no image sensor. In other examples, actuator assembly 1 may be a type of apparatus that is not an optical device, and in which the movable part is not a lens element and there is no image sensor. Examples include apparatuses for depth mapping, face recognition, game consoles, projectors and security scanners.

The actuator assembly 1 also comprises a helical bearing arrangement 20 (shown schematically in FIG. 1) that supports the movable part 10 on the support structure 2. The helical bearing arrangement 20 is arranged to guide helical movement of the movable part 10 with respect to the support structure 2 around a helical axis H. The helical axis H in this example is coincident with the optical axis O and the helical movement along a helical path is shown in FIG. 1 by the arrow M. Preferably, the helical motion is along a right helix, that is a helix with constant radius, but in general any helix is possible. The pitch of the helix may be constant or vary along the helical motion. Preferably, the helical movement is generally only a small portion (less than one quarter) of a full turn of the helix.

The helical motion of the movable part 10 guided by the helical bearing arrangement 20 includes a component of translational movement along the helical axis H and rotational movement around the helical axis H. The translational movement along the helical axis H is the desired movement of the movable part 10, for example to change the focus of the image on the image sensor 3 and/or to change the magnification (zoom) of the image on the image sensor 3. The rotational movement around the helical axis H is in this example not needed for optical purposes, but is in general acceptable as rotation of the movable part 10 does not change the focus of the image on the image sensor 3.

### Driving Rotation of the Movable Part

FIG. 2 is a schematic view of an actuator assembly 1. The actuator assembly 1 comprises at least one actuator component. Optionally the actuator component is an SMA element, for example an SMA wire 40. The actuator assembly 1 depicted in FIG. 2 comprises SMA wires 40 as the actuator components. However, other types of actuator components may be used.

The actuator component is arranged, on actuation, to drive rotation of the movable part 10 around the helical axis H. The helical bearing arrangement 20 converts the rotation of the movable part 10 into the helical movement of the movable part 10 relative to the support structure 2 around the helical axis H.

Optionally only one actuator component is provided. The actuator component may be arranged, on actuation, to drive rotation of the movable part 10 in one sense around the helical axis H. The helical bearing arrangement 20 converts the rotation into helical movement in one helical direction (i.e. in one sense). Another component such as a resilient member may drive rotation of the movable part 10 in the opposite sense around the helical axis H which the helical bearing arrangement 20 converts into helical movement in the opposite sense.

In preferred embodiments, the actuator assembly 1 comprises a plurality of actuator components, such as a pair of actuator components. For example, as shown in FIG. 2 the actuator assembly 1 may comprise two SMA wires 40 as actuator components. Only one of the SMA wires 40 is visible from the angle of FIG. 2. As shown in FIG. 2, optionally the SMA wire 40 is connected between the support structure 2 and the movable part 10. The SMA wire 40 may be connected to the support structure 2 via a connection element such as a static crimp 41. The SMA wire 40 may be connected to the movable part 10 via a connection element such as a moving crimp 42. In general, any connection element capable of fixing the SMA wire to the support structure 2 and/or movable part 10 may be used. The second SMA wire 40 which is not visible in FIG. 2 is provided at the lower side (in the orientation shown in FIG. 2) of the actuator assembly 1. The moving crimp 42 for connecting the second SMA wire 40 to the movable part 10 can be seen in FIG. 2.

Optionally, the actuator assembly 1 comprises at least one pair of actuator components (e.g. SMA wires 40) arranged, on actuation, to drive rotation of the movable part 10 in opposite senses around the helical axis H. The helical bearing arrangement converts the rotation of the movable part 10 into the helical movement. The two SMA wires 40 can be actuated to cause helical movement along the helical axis H in opposite senses. The SMA wires 40 may be controlled (i.e. actuated) so as to control the position of the movable part 10 along the helical axis H, for example within a range of movement of the movable part 10 relative to the support structure 2.

Optionally, the SMA wires 40 are driven by a control circuit or controller implemented in the IC chip 5. In particular, the control circuit may generate drive signals (e.g. PWM drive signals) for each of the SMA wires 40 and supply the drive signals to the SMA wires. The control circuit receives an input signal representing a desired position for the movable part 10 along the optical axis O and generates drive signals selected to drive the movable part 10 to the desired position.

The drive signals may be generated using a resistance feedback control technique, in which case the control circuit measures the resistance of the lengths of the SMA wires 40 and uses the measured resistance as a feedback signal to control the power of the drive signals.

As an alternative, the control circuit may include a sensor which senses the position of the movable part 10, for example a Hall sensor which senses the position of a magnet fixed to the movable part 10. In this case, the drive signals use the sensed position as a feedback signal to control the power of the drive signals.

### Loading Arrangement

As shown in FIG. 2, the actuator assembly 1 comprises a loading arrangement 50 (which may also be referred to as a biasing arrangement). The loading arrangement 50 is arranged between the support structure 2 and the movable part 10. The loading arrangement 50 is for loading the helical bearing arrangement 20. Loading the helical bearing arrangement 20 means urging the different parts (e.g. bearing surfaces) of the helical bearing arrangement 20 towards each other.

If the helical bearing arrangement 20 is not loaded (i.e. is unloaded), then the helical bearing arrangement 20 may not be capable of converting rotation of the movable part 10 into helical movement. If the helical bearing arrangement 20 is not loaded, then the bearing surfaces of a sliding bearing may lose contact with each other and/or bearing surfaces may lose contact with a rolling bearing between the bearing surfaces. By loading the helical bearing arrangement 20, the helical bearing arrangement 20 may reliably guide helical movement of the movable part 10 relative to the support structure 2 around the helical axis 2.

In the actuator assembly 1 shown in FIG. 2, the loading arrangement 50 comprises a pair of resilient elements 51 (e.g. springs). The resilient elements 51 exert a force that urges the helical bearing arrangement 20 together. The loading arrangement 50 may be provided in a variety of different forms, as explained in further detail below.

As shown in FIG. 2, optionally each resilient element 51 is connected between the support structure 2 and the movable part 10. The resilient element 51 may be fixedly connected at one end to the support structure 2, and at another end to the movable part 10. The resilient element 51 may comprise a static part 52 that engages with the support structure 2. For example, the static part 52 may be fixed directly to the support structure 2. The resilient element 51 may comprise a moving part 53 that engages with the movable part 10. For example, the moving part 53 may be fixed to the movable part 10.

As shown in FIG. 2, optionally the moving part 53 of the resilient element 51 and the moving crimp 42 may be provided as an integral component. However, this is not essential. In an alternative arrangement the moving part 53 of the resilient element 51 and the moving crimp 42 may be provided as separate components. The moving part 53 of the resilient element 51 and the moving crimp 42 may both be fixed relative to the movable part 10.

### Unloading Torque

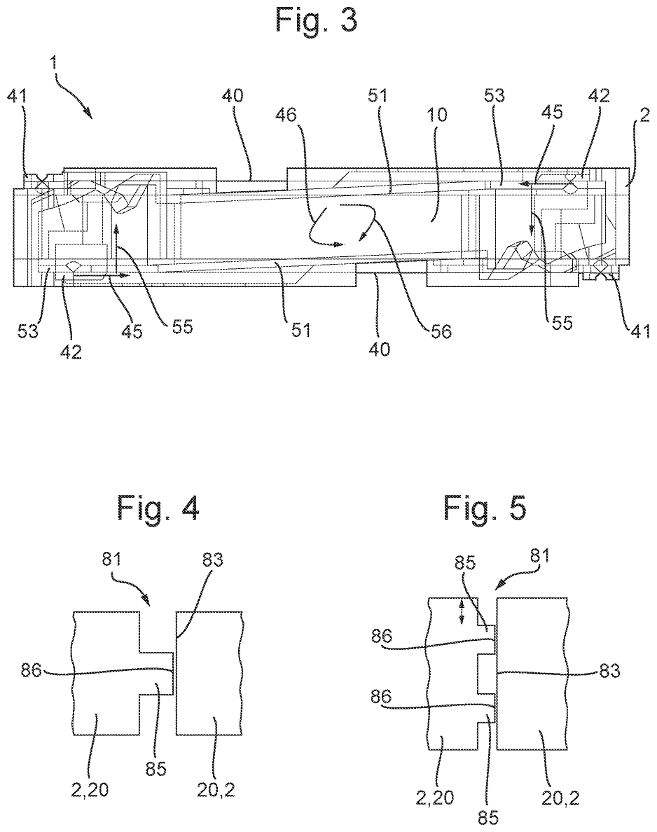

FIG. 3 is a schematic side view of the actuator assembly 1 shown in FIG. 2. The two SMA wires 40 that are the actuator components can be seen in FIG. 3.

FIG. 3 shows force arrows 45 indicating the direction of forces applied by the SMA wires 40. These are forces that are applied to the movable part 10. The upper force arrow 45 shown in FIG. 3 shows the force applied to the movable part 10 to urge the movable part in the direction from right to left. This force is applied when the SMA wire 40 at the top of FIG. 3 is contracted. At the bottom of FIG. 3 the other force arrow 45 shows the force applied to the movable part 10 by contraction of the SMA wire 40 shown at the bottom of FIG. 3.

FIG. 3 further shows an unloading torque arrow 46. The unloading torque arrow 46 indicates the general direction of the unloading torque formed by a combination of the force arrows 45 applied by the SMA wires 40 as actuator components.

As shown in FIG. 3, optionally the at least one pair of actuator components (e.g. SMA wires 40) is arranged to apply an unloading torque 46 about an axis perpendicular to the helical axis H so as to reduce loading of the helical bearing arrangement 20. In the actuator assembly shown in FIG. 3, the axis about which the unloading torque 46 is applied is an axis that extends into and out from the drawing sheet. The axis may be generally perpendicular to the length of the SMA wires 40 and perpendicular to the helical axis H.

By providing an unloading torque so as to reduce loading of the helical bearing arrangement 20, the extent of loading of the helical bearing arrangement 20 may be varied in a controlled manner. For example, when it is desirable to move the movable element 10 along the helical axis H, then the loading of the helical bearing arrangement 20 may be reduced by applying the unloading torque 46. By reducing loading of the helical bearing arrangement 20, the friction in the helical bearing arrangement 20 (or generally the resistance to motion in the helical bearing arrangement 20) may be reduced. This allows the movable part 10 to move more freely relative to the support structure 2. Of course, it is desirable for the helical bearing arrangement 10 to remain loaded at least to some extent so that the helical bearing arrangement 20 can continue to reliably convert rotation of the movable part 10 into the helical movement during use of the actuator assembly 1. It is desirable for the unloading torque 46 to be less than a threshold amount which would result in the helical bearing arrangement 20 becoming unloaded.

By providing that the unloading torque 46 is applied by the actuator components that drive rotation of the movable part 10 and cause the movable part 10 to move helically, the loading of the helical bearing arrangement 20 can be controlled without requiring additional components for controlling the loading of the helical bearing arrangement 20. The actuator components may be provided already in such an actuator assembly 1. The actuator components are controlled in a new way so as to control loading of the helical bearing arrangement 20.

By providing that the loading of the helical bearing arrangement 20 is reduced by an unloading torque 46 about an axis perpendicular to the helical axis H, the possibility of the unloading torque 46 itself directly resulting in helical movement of the movable part 10 is reduced. For example, if the reduction in loading of the helical bearing arrangement 20 were achieved by applying a force that acts primarily or purely along the helical axis H, then the unloading force itself may cause the movable part 10 to move along the helical axis H. Hence the helical movement of the movable part 10 may be affected in an undesirable way. By providing the unloading torque 46 about the axis perpendicular to the helical axis H, undesirable effects on the helical movement may be reduced.

Meanwhile, when helical movement of the movable part 10 is not desired (for example when it is desired for the movable part 10 to maintain its position relative to the support structure 2), the loading of the helical bearing arrangement 20 may be increased. For example, the unloading torque 46 may be reduced so as to reduce any reduction in loading of the helical bearing arrangement 20 caused by the unloading torque 46. By increasing loading of the helical bearing arrangement 20, friction within the helical bearing arrangement 20 may be increased. The friction may help to reduce the amount of power required by the actuator components in order to keep the position of the moveable part 10 relative to the support structure 2. It is possible that the power required to maintain the position of the movable part 10 along the helical axis H may be eliminated. In other words, when the actuator components are not actuated, the friction within the helical bearing arrangement 20 may be sufficient to keep the movable part 10 in position relative to the support structure 2. This may be referred to as zero hold power.

As shown in FIG. 3, optionally the at least one pair of actuator components (e.g. SMA wires 40) are arranged to apply forces to the movable part 10 relative to the support structure 2 that are offset from each other along the helical axis H. This offset along the helical axis H allows the forces to combine to form the unloading torque 46 about an axis perpendicular to the helical axis H. In the example shown in FIG. 3, the actuator components are SMA wires 40. In such a case, the SMA wires 40 may be arranged to be offset from each other along the helical axis H. The axis about which the unloading torque 46 is applied may be between the forces applied by the actuator components, for example between the SMA wires 40 when the SMA wires 40 are the actuator components. The forces applied by the SMA wires 40 act in the direction of the SMA wires 40.

As shown in FIG. 3, optionally the at least one pair of actuator components are arranged to apply forces in opposite directions perpendicular to the helical axis H such that the unloading torque 46 can be applied without applying an overall force perpendicular to the helical axis H. The force arrows 45 shown in FIG. 3 generally oppose each other. The force arrows 45 are generally perpendicular to the helical axis H. The force arrows 45 are in the direction of the SMA wires 40 themselves. The SMA wires 40 may be generally perpendicular to the helical axis H. In general, however, the SMA wires 40 may be oriented at an acute angle relative to the perpendicular to the helical axis H. When the movable part 10 moves along the helical axis H relative to the support structure 2, the angle of orientation of the SMA wires 40 may vary. However, the forces and the SMA wires 40 may remain generally approximately perpendicular to the helical axis H (or at least at an acute angle perpendicular to the helical axis H). Optionally, the forces applied by the SMA wires 40 could be equal to each other in magnitude but applied in opposite directions. This would result in no overall force perpendicular to the helical axis H. However, the unloading torque 46 could still be applied. This means that the loading of the helical bearing arrangement 20 can be controlled without adversely affecting the control of the helical position of the movable part 10 relative to the support structure 2.

Of course, it may be desirable to apply different forces by the different SMA wires 40. For example, it may be desirable to drive rotation of the movable part 10 so as to move the movable part 10 in the helical direction. Additionally or alternatively, it may be desirable to control a difference in forces applied by the SMA wires 40 in order to counteract other external forces such as gravity.

### Loading Torque

FIG. 3 further shows loading force arrows 55. The loading force arrows 55 show the forces applied to the movable part 10 by the loading arrangement 50, in particular by the resilient elements 51 of the specific loading arrangement 50 shown in FIG. 3. For example, the moving part 53 of the resilient element 51 which is engaged with the movable part 10 may urge the movable part 10 by a force that acts generally in parallel with the helical axis H. As shown in FIG. 3, optionally the loading arrangement 50 is arranged to apply a loading torque 56 about an axis perpendicular to the helical axis H for loading the helical bearing arrangement 20. The loading torque providing by the loading arrangement 50 may be in a sense opposite to the unloading torque provided by the actuator components, in embodiments in which both the loading and unloading torques are provided.

As shown in FIG. 3, the forces applied by the resilient elements 51 on the movable part 10 act generally in the directions parallel to the helical axis H. However, the two forces applied by the two resilient elements 51 of the loading arrangement 50 act on either side of the helical axis H. The helical axis H is between the loading force arrows 55. This creates a loading torque 56. The axis about which the loading torque 56 is applied is an axis that extends into and out from the drawing sheet.

By providing that the loading of the helical bearing arrangement 20 is achieved by a loading torque 56 about an axis perpendicular to the helical axis H, the possibility of the forces that load the helical bearing arrangement 20 undesirably affecting the helical movement is reduced. It is desirable for the forces that load the helical bearing arrangement 20 not to act in a direction that could cause helical movement of the movable part 10 relative to the support structure 2.

For example, as shown in FIG. 3 the two loading force arrows 55 for the resilient elements 51 of the loading arrangement 50 act generally in opposite directions to each other. As a result, the overall force in the direction of the helical axis H may be small or even zero. As a result, the loading arrangement 50 itself may not significantly drive helical movement of the movable part 10 relative to the support structure 2. This may help the helical movement of the movable part 10 to be controlled more accurately by controlling rotation of the movable part 10 by the actuator components.

### Zero Hold Power

Zero hold power actuators have a benefit of using no power when holding a position. This is particularly advantageous for devices that have limited power (e.g. a limited peak power) and/or energy (e.g. a limited average power). For example, wearables may have limited power and/or energy. Other battery powered devices may similarly have limited power and/or energy available.

It may be desirable for the helical bearing arrangement 20 to have sufficient friction to hold the movable part in position against inertial roads. The helical bearing arrangement 20 may be generally good at resisting linear forces caused by shocks, for example. Such a linear force may increase friction on one or more of the helical bearings of the helical bearing arrangement 20, thereby actually increasing the resistance to motion.

Optionally, the helical bearing arrangement 20 is arranged to have sufficient friction when loaded that the movable part 10 remains in position when the actuator components are not driving rotation of the movable part 10. The helical bearing arrangement 20 is arranged to have sufficient friction when loaded that the movable part 10 remains in position when the actuator components are not providing an unloading torque. This allows the power and energy requirements of the actuator assembly 1 to be reduced while allowing the position of the movable part 10 to be controlled and maintained. For example, the actuator assembly 1 may be used in the context of an autofocus function of a camera. It may be desirable to maintain a focussed position of the movable part 10 relative to the support structure 2 between shots taken by the camera. In another example, the actuator assembly 1 may be used in the context of providing athermilization in an optical system. It may be desirable to maintain a position of the movable part 10 relative to the support structure 2 while the ambient temperature remains constant.

Optionally, the helical bearing arrangement 20 is arranged to have sufficient friction when loaded that the movable part 10, over a continuum of positions, remains in position when the actuator components are not driving rotation of the movable part 10. This may allow the movable part 10 to be controlled to maintain any arbitrary helical position relative to the support structure 2, at least within a range of movement of the movable part 10 relative to the support structure 2. This is an improvement over ratchet-type systems which may maintain the position of a component but only at a set of discrete intervals. The friction within the helical bearing arrangement 20 may allow the movable part 10 to be held at any of a continuum of positions.

Optionally, the loading arrangement 50 is arranged to load the helical bearing arrangement 20 so as to generate frictional forces therein that constrain the movement of the movable part 10 relative to the support structure 2 at any position within a range of movement when the actuator components are not actuated. The constraining of the movable part 10 may be such that the helical position of the movable part 10 is maintained relative to the support structure 2. Once a desirable position of the movable part 10 has been found, it is not necessary to again control the helical movement of the movable part 10 in order to maintain that desirable position for a subsequent process (e.g. taking of a photograph with a camera).

Optionally, the pair of actuator components is arranged, on actuation, to apply the unloading torque 46 so as to reduce the frictional forces in the helical bearing arrangement 20. As shown in FIG. 3, the unloading torque 46 counteracts the loading torque 56. The loading torque 56 and the unloading torque 46 may be about the same axis perpendicular to the helical axis H. The unloading torque 46 acts to cancel out part of the loading torque 56. Of course, the loading torque 56 may overall remain greater than the unloading torque 46 such that the helical bearing arrangement 20 remains loaded, at least to an extent. By reducing the frictional forces in the helical bearing arrangement 20, the ease of movement of the movable part 10 relative to the support structure 2 may be controlled. For example, when it is desirable to maintain the position of the movable part 10, the friction can be increased by reducing the unloading torque 46. When it is desirable to move the movable part 10 helically (in either sense), then the unloading torque 46 may be increased so as to reduce the friction within the helical bearing arrangement 20.

### Sliding Bearing

The helical bearing arrangement 20 may take a variety of forms.

One possibility is that the helical bearing arrangement 20 comprises one or more helical bearings 30 that are sliding bearings, examples of which are shown in FIGS. 4-7. In the first example shown in FIGS. 4 and 5, the sliding bearing is a plain bearing 81 that comprises an elongate bearing surface 83 on one of the support structure 2 and the movable part 10. The plain bearing 81 also comprises protrusions 85 formed on the other of the support structure 2 and movable part 10, the ends of the protrusions 85 forming bearing surfaces 86 which bear on the elongate bearing surface 83. Although two protrusions 85 are shown in this example, in general any number of one or more protrusions 85 may be provided. The elongate bearing surface 83 and the bearing surfaces 86 are conformal, both being planar in this example, so as to permit relative movement of the movable part 10 with respect to the support structure 2. The elongate bearing surface 83 and the bearing surfaces 86 desirably have a coefficient of friction of 0.2 or more. A higher coefficient of friction may reduce or eliminate the power and/or energy to keep the movable part 10 in position.

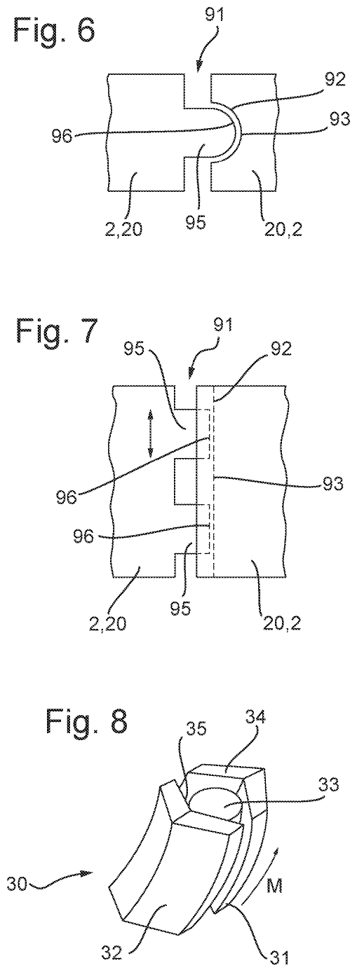

In the second example shown in FIGS. 6 and 7, the sliding bearing is a plain bearing 91 that comprises a channel 92 on one of the support structure 2 and the movable part 10, the inner surface of the channel 92 forming a bearing surface 93. The plain bearing 91 comprises protrusions 95 formed on the other of the support structure 2 and movable part 10, the ends of the protrusions 95 forming bearing surfaces 96 which bear on the bearing surface 93. Although two protrusions 95 are shown in this example, in general any number of one or more protrusions 95 may be provided. The elongate bearing surface 93 and the bearing surfaces 96 are conformal, both being planar in this example, so as to permit relative movement of the movable part 10 with respect to the support structure 2. The elongate bearing surface 93 and the bearing surfaces 96 desirably have a coefficient of friction of 0.2 or more. A higher coefficient of friction may reduce or eliminate the power and/or energy to keep the movable part 10 in position. In general, however, lower coefficients of friction may be used and offset by larger loading forces so as to provide zero hold power, and vice versa. The loading arrangement and friction surfaces of the helical bearing arrangement may thus be designed to work together to provide zero hold power.

In each of the plain bearings 81 and 91, the materials of the bearing surfaces 83, 86, 93, 96 are chosen to provide smooth movement and a long life. The bearing surfaces 83, 86, 93, 96 may be unitary with the underlying component or may be formed by a surface coating. Suitable materials include, for example PTFE or other polymeric bearing materials, or metal.

In each of the plain bearings 81 and 91, a lubricant may be provided on the bearing surfaces 83, 86, 93, 96. Such a lubricant may be a powder or a fluid, for example. Suitable lubricants include: graphite; silicon paste or a low viscosity oil.

### Rolling

As mentioned above, the helical bearing arrangement 20 may take a variety of forms.

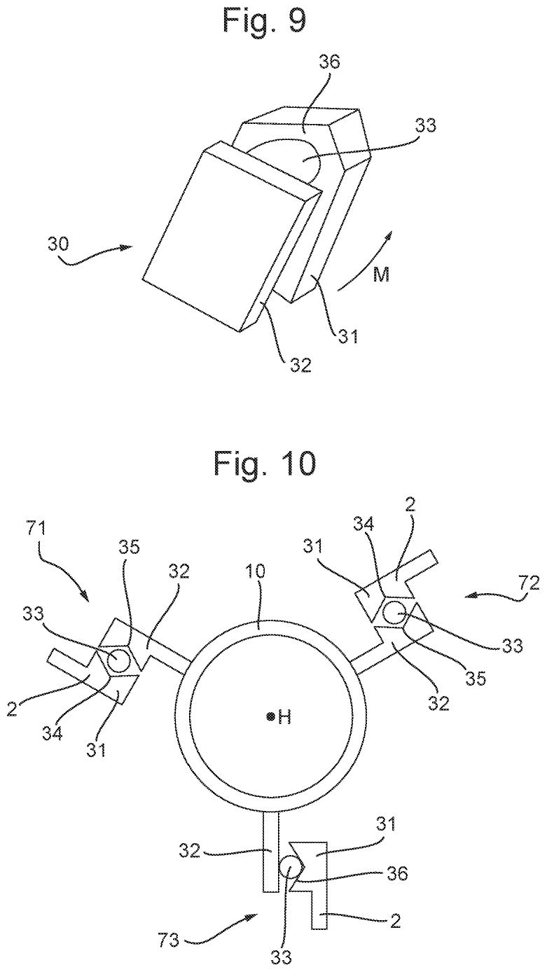

Another possibility is that the helical bearing arrangement 20 comprises one or more helical bearings 30 that are rolling bearings, examples of which are shown in FIGS. 8 and 9. In each of FIGS. 8 and 9, the helical bearing 30 comprises a pair of bearing surfaces 31 and 32 and plural rolling bearing elements 33, for example balls, disposed between the bearing surfaces 31 and 32. One of the bearing surfaces 31 and 32 is provided on the support structure 2 and the other of the bearing surfaces 31 and 32 is provided on the movable part 10.

The helical bearing 30 guides the helical movement of the movable part 10 with respect to the support structure 2 as shown by the arrow M. This may be achieved by the bearing surfaces 31 and 32 extending helically around the helical axis H, that is following a line that is helical. That said, in practical embodiments, the length of the bearing surfaces 31 and 32 may be short compared to the distance of the bearing surfaces 31 and 32 from the helical axis H, such that their shape is close to straight or even each being straight, provided that the one or more helical bearings of the helical bearing arrangement 20 guide helical movement of the movable part 10 with respect to the support structure 2. Plural helical bearings 30 are typically present, located at different angular positions around the helical axis H, in which case the helical bearings 30 have different orientations so that they cooperate and maintain adequate constraints to guide the helical movement of the movable part 10 with respect to the support structure 2, even if the bearing surfaces 31 and 32 of an individual helical bearing 30 are straight.

In the example of FIG. 8, the bearing surfaces 31 and 32 each comprise respective grooves 34 and 35 in which the rolling bearing elements 33 are seated. In this example, the grooves 34 and 35 constrain transverse translational movement of the movable part 10 with respect to the support structure 2, that is transverse to the direction of movement shown by arrow M. The grooves shown in FIG. 8 are V-shaped in cross-section, but other cross-sections are possible, for example curved as in portions of a circle or an oval. In general, the grooves 34 and 35 provide two points of contact with the respective rolling bearing elements 33. The grooves 34 and 35 may extend helically. Alternatively, in practical embodiments, the length of the bearing surfaces 31 and 32 may be short compared to the distance of the bearing surfaces 31 and 32 from the helical axis H, in which case the grooves 34 and 35 may be straight or close to straight, provided that the one or more helical bearings 30 of the helical bearing arrangement 20 guide helical movement of the movable part 10 with respect to the support structure 2.

In the example of FIG. 9, a first bearing surface 31 comprises a groove 36 in which the rolling bearing elements 33 are seated and a second bearing surface 32 wherein the bearing surface is ‘planar’. The first bearing surface 31 comprising a groove 36 may be provided on either one of the support structure 2 and the movable part 10, with the second bearing surface 32 being provided on the other one of the support structure 2 and the movable part 10. In the example of FIG. 9, the helical bearing 30 does not constrain transverse translational movement of the movable part 10 with respect to the support structure 2, that is transverse to the direction of movement shown by arrow M. The bearing surface 32 is ‘planar’ in the sense that it is a surface which is not a groove and one which provides only a single point of contact with the ball. In other words, the bearing surface 32 is effectively planar across a scale of the width of the rolling bearing element 33, although be helical at a larger scale. For example, as pictured, the ‘planar’ surface is helical, being a line in cross section which twists helically along the movement direction, maintaining a single point of contact with the ball at any time. Alternatively and as mentioned above, in practical embodiments the length of the bearing surfaces 31 and 32 may be short, in which case the bearing surface 32 may be planar or close to planar, provided that the one or more helical bearings 30 of the helical bearing arrangement 20 guide helical movement of the movable part 10 with respect to the support structure 2.

A single rolling bearing element 33 is shown in FIGS. 8 and 9 by way of example, but in general may include any plural number of rolling bearing elements 33.

In some examples, the helical bearing 30 may include a single rolling bearing element 33. In that case, the helical bearing 30 by itself does not constrain the rotational movement of the movable part 10 with respect to the support structure 2 about the single rolling bearing element 33, that is around an axis transverse to the direction of movement shown by arrow M. However, this minimises the overall size of the helical bearing 30, and in particular the height of the helical bearing 30 projected along the helical axis H as it is only needed to accommodate the size of the rolling bearing element 33 and the relative travel of the bearing surfaces 31 and 32.

In other examples, the helical bearing 30 may include plural rolling bearing elements 33. In that case, the helical bearing 30 constrains the rotational movement of the movable part 10 with respect to the support structure 2 about either one of the rolling bearing elements 33, that is around an axis transverse to the direction of movement shown by arrow M. However, compared to use of a single rolling bearing element 33, this increases the overall size of the helical bearing 30, and in particular the height of the helical bearing 30 projected along the helical axis H.

The helical bearing arrangement may in general comprise any number of helical bearings 30 with a configuration chosen to guide the helical movement of the movable part 10 with respect to the support structure 2 while constraining the movement of the movable part 10 with respect to the support structure 2 in other degrees of freedom. Many helical bearing arrangements may comprise plural helical bearings 30 and at least one which comprises plural rolling bearing elements 30.

### Helical Bearing Arrangement

FIG. 10 illustrates a possible helical bearing arrangement that includes three helical bearings 71, 72 and 73 only. Optionally the three helical bearings 71, 72 and 73 are equally angularly spaced around the helical axis H, but they could alternatively be spaced unequally.

Optionally the first and second helical bearings 71 and 72 are of the same type as the helical bearing 30 shown in FIG. 8 wherein the bearing surfaces 31 and 32 each comprise respective groove 34 and 35.

The third helical bearing 73 is of the same type as the helical bearing 30 shown in FIG. 9 wherein the first bearing surface 31 comprises a groove 36 in which the rolling bearing element 33 is seated and the second bearing surface 32 is planar. FIG. 10 illustrated the case that the first bearing surface 31 of the third helical bearing 73 is on the movable part 10, but it could alternatively be on the support structure 2.

Each of the three helical bearings 71, 72 and 73 may comprise a single rolling or plural bearing elements 33. This is possible because the constraints imposed by the three helical bearings 71, 72 and 73, and in particular the grooves of the first and second helical bearings 71 and 72, are sufficient to constrain the movement of the movable part 10 with respect to the support structure 2 in degrees of freedom other than the helical movement. As a result of using only a single rolling bearing element 33 in each of the three helical bearings 71, 72 and 73, the overall size of the three helical bearings 71, 72 and 73, and in particular the height of the three helical bearings 71, 72 and 73 projected along the helical axis H is reduced.

Optionally, one or more of the helical bearings shown in FIG. 10 may be replaced with one or more sliding bearings. For example, a sliding bearing may comprise a groove in one of the support structure 2 and the movable part 10, with a complimentarily shaped member in the other of the support structure 2 and the movable part 10. This may provide sufficient constraints to constrain movement of the movable part 10 with respect to the support structure 2 in degrees of freedom other than the helical movement.

Optionally the at least one pair of actuator components is arranged to reduce loading of the helical bearing arrangement 20 by less than the loading applied by the loading arrangement 50. This allows the helical bearing arrangement 20 to continue to convert the rotation of the movable part 10 accurately into the helical movement.

### Resilient Elements

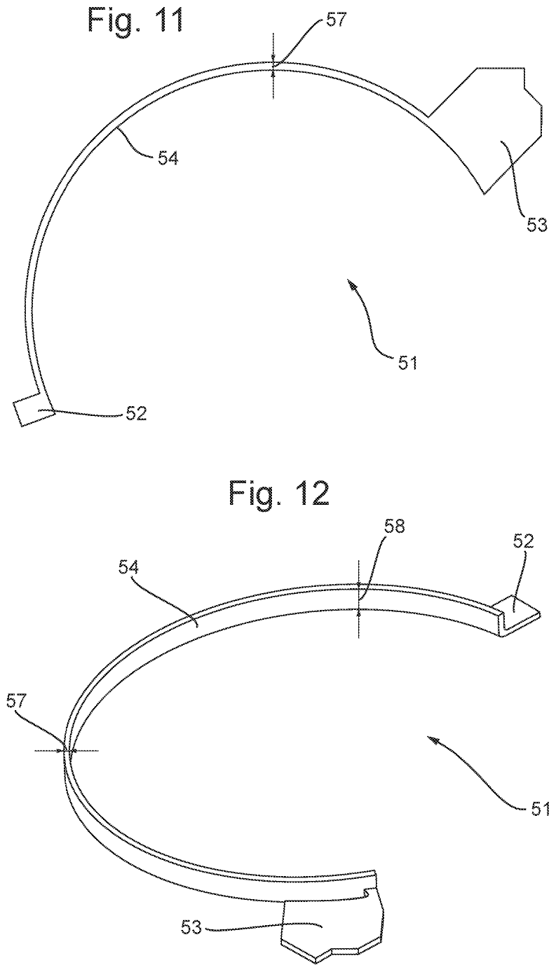

FIG. 11 is a schematic view of one of the resilient elements 51 of the loading arrangement 50. For example, the resilient element 51 shown in FIG. 11 may be of the type shown in the actuator assembly 1 of FIG. 2 and FIG. 3. Optionally the loading arrangement 50 comprises a resilient loading arrangement for resiliently loading the helical bearing arrangement 20. A resilient loading arrangement has the advantage that it does not need to be actuated in order to apply the load to the helical bearing arrangement 20. For example, the resilient element 51 may be preloaded such that when it is mounted within the actuator assembly 1 it acts to urge the movable part 10 relative to the support structure 2 so as to provide the loading torque 56.

As shown in FIG. 3, optionally the resilient loading arrangement comprises a pair of resilient elements 51. The resilient elements 51 are between the support structure 2 and the movable part 10. For example, the resilient elements 51 may be connected between the support structure 2 and the movable part 10. For example, the resilient element 51 may comprise a static part 52 configured to be fixed to the support structure 2 and a moving part 53 configured to be fixed to the movable part 10.

By providing a pair of resilient elements 51, a loading torque may be provided by combining the forces applied on the movable part 10 by the two resilient elements 51.

Optionally, the resilient loading arrangement comprises at least one resilient element 51 between the support structure 2 and the movable part 10. The resilient element 51 may comprise at least a portion 54 extending between the support structure 2 and the movable part 10 that is at least as thick in a direction parallel to the helical axis H as in a direction perpendicular to the helical axis H. For example, the thickness 57 of the portion 54 of the resilient element 51 in a direction perpendicular to the helical axis H is shown in FIG. 11. Optionally, the thickness of the portion 54 parallel to the helical axis H (i.e. the thickness of the portion 54 in a direction into and out from the page) is at least as great as the thickness 57 in a direction perpendicular to the helical axis H. This may help to reduce lateral forces (i.e. forces in a direction perpendicular to the helical axis H at the edges of the stroke i.e. at the extreme positions of the movable part 10 along the helical axis H (in either direction). By providing a resilient element 51 that is relatively thick in the direction parallel to the helical axis H, the force applied by the resilient element 51 may be much larger in the direction parallel to the helical axis H than in a direction perpendicular to the helical axis H. This helps to reduce the lateral forces.

As the movable part 10 moves along the helical axis H, the forces applied on the movable part 10 by the resilient elements 51 varies. This is because the shape and/or orientation of the resilient element 51 changes. In particular, the distance along the helical axis H between the parts 52, 53 of the resilient element 51 that engage with the support structure to and the movable part 10 varies as the movable part 10 moves. By providing a relatively thick (in the direction of the helical axis H) resilient element 51, the change in the desired preload force over the stroke may be reduced.

As mentioned above, the resilient element 51 may be preloaded with stress so that it applies a force on the movable part 10 when it is mounted in the actuator assembly 1. Optionally, the resilient loading arrangement comprises at least one resilient element 51 between the support structure 2 and the movable part 10. The resilient element 51 is stressed in its mounted position connected between the support structure 2 and the movable part 10 so as to load the helical bearing arrangement 10. By this, parts 52, 53 of the resilient element 51 that engage with the support structure 2 and the movable part 10 are less distanced in a direction along the helical axis H than if the resilient element 51 were not stressed.

During manufacture of the resilient element 51, the resilient element 51 may be bent, for example a jog may be included in the resilient element 51. When the resilient element 51 is incorporated into the actuator assembly 1, it is mounted in a position so as to be deformed (e.g. to a more flat shape) compared to the bent shape during manufacture. Hence, there is a difference in the distance or extent along the helical axis H between the parts 52, 53 of the resilient element 51 when the resilient element 51 is mounted in the actuator assembly 1 compared to before it is mounted. So, the resilient element 51 may be pre-loaded during manufacture. Optionally, this difference is greater than a possible range of movement (i.e. stroke) of the movable part 10 along the helical axis H. For example, optionally the possible range of movement of the movable part 10 along the helical axis is at least 10 μm, and optionally at least 20 μm. Optionally, the range of possible movement of the movable part 10 along the helical axis H is at most 100 μm optionally at most 50 μm. Meanwhile, optionally the preload distance of the resilient element 51 may be at least 100 μm, optionally at least 200 μm and optionally at least 500 μm. The preload distance is the difference in distance along the helical axis H between the parts 52, 53 of the resilient element 51 before the resilient element is mounted into the actuator assembly 1 (but when the parts 52, 53 are oriented perpendicular to the helical axis H) and after mounting. By providing that the preload distance is greater than the stroke, the change of the preload over the range of movement of the movable part will be relatively small. This can help to keep the lateral force low at the limit of stroke.

FIG. 12 is a schematic perspective view of another version of the resilient element 51 of the loading arrangement 50. As shown in FIG. 12, optionally the resilient loading arrangement comprises at least one resilient element 51 between the support structure 2 and the movable part 10. The resilient element 51 is stiffer to bending around an axis perpendicular to the helical axis H than to bending around the helical axis H. For example, as shown in FIG. 12, optionally the thickness 58 of the portion 54 between the parts 52, 53 that engage with the support structure 2 and the movable part 10 is greater than the thickness 57 in a direction perpendicular to the helical axis H. The thickness 58 is parallel to the helical axis H. For example, as shown in FIG. 12 optionally the resilient element 51 comprises a folded section that forms the portion 54. The folded section increases the vertical force without increasing the lateral force. Optionally the resilient element 51 is stiff in the preload direction while compliant in the lateral direction.

It is not essential for the resilient element 51 to have been folded in order to be stiff in the preload direction while compliant in the lateral direction. As an alternative, the portion 54 may be fixed to the parts 52, 53 of the resilient element 51. For example, the portion 54 may be welded or adhered (e.g. glued) to create the low aspect ratio (i.e. the thickness 57 perpendicular to the helical axis H being less than the thickness 58 parallel to the helical axis H).

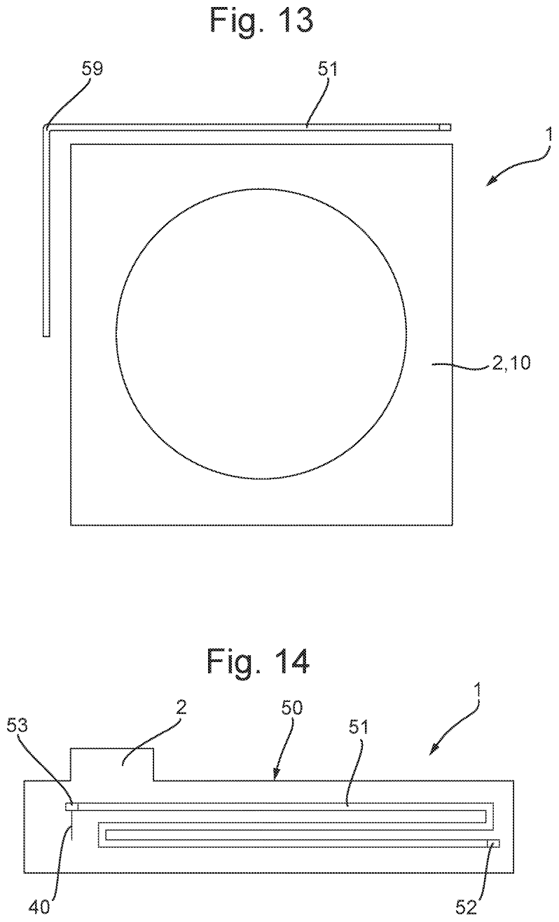

FIG. 13 is a schematic plan view of an actuator assembly 1. As shown in FIG. 13, optionally the loading arrangement 50 comprises at least one resilient element 51 that is placed along the side of the actuator (i.e. the support structure 2 and the movable part 10). The resilient element 51 may be bent around a corner so as to reduce its lateral stiffness. The resilient element 51 may comprise a bend 59. By providing the bend 59, the resilient element 51 may be more compliant to lateral movements, i.e. movements in a direction perpendicular to the helical axis H. Although not shown in FIG. 13, the resilient element 51 may be fixedly connected to the support structure 2 and the movable part 10.

Optionally, the resilient element 51 is thicker in a direction parallel to the helical axis than in a direction perpendicular to the helical axis. This may help to reduce the lateral stiffness of the resilient element 51.

By providing the resilient element 51 on the side of the actuator, it may not be necessary to perform processes such as welding or making complex folds to a curved resilient element 51. This may help to simplify the manufacture of the actuator assembly 1.

FIG. 14 is a schematic side view of an actuator assembly 1. As shown in FIG. 14, optionally the loading arrangement 50 comprises at least one resilient element 51 that comprises a meander. For example, as shown in FIG. 14, the resilient element 51 may be snaked on the side of the actuator. The resilient element 51 may optionally be connected to the support structure 2 and the movable part 10 by the parts 52, 53. By providing the resilient element 51 with a meander, the overall length of the resilient element 51 (i.e. its length if it were pulled out straight without any bends) may be increased. By increasing the length of the resilient element 51, the lateral force exerted by the resilient member 51 may be reduced.

FIG. 14 shows a resilient element 51 with a meander. As an alternative, the resilient element 51 may be coiled to provide the increased length of the resilient element 51. This may help to reduce the change in preload force over the stroke (i.e. the possible movement of the movable part 10 relative to the support structure 2).

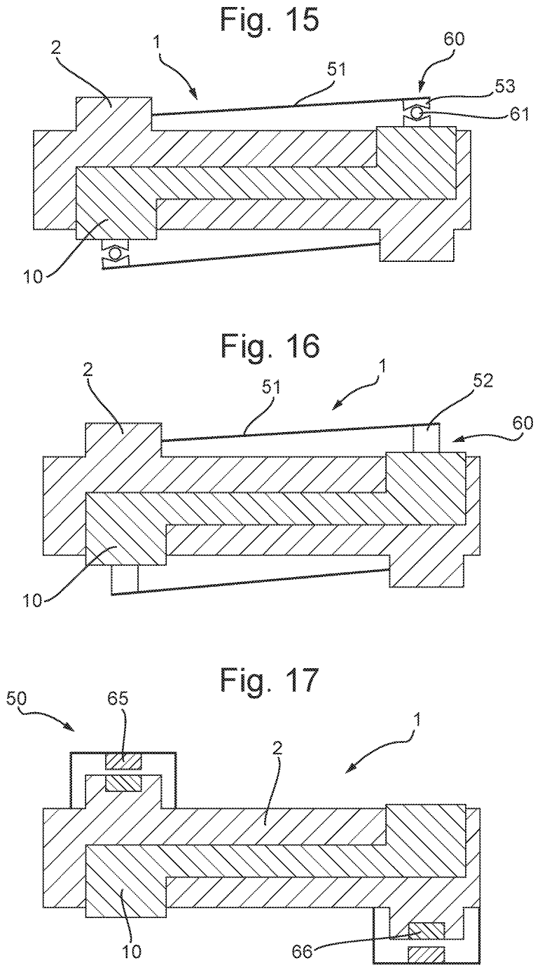

FIG. 15 is a schematic side view of an actuator assembly 1. As shown in FIG. 15, optionally the resilient loading arrangement comprises at least one resilient element 51 that engages with at least one of the support structure 2 and the movable part 10 via a bearing arrangement 60. In the example shown in FIG. 15, the resilient element 51 may be fixedly connected to the support structure 2. However, the other end of the resilient element 51 engages with the movable part 10 via the bearing arrangement 60. Optionally, the bearing arrangement 60 comprises the moving part 53 of the resilient element 51. The moving part 53 may define a bearing surface of the bearing arrangement 60. Another bearing surface of the bearing arrangement 60 may be defined by the movable part 10, or a component (e.g. a protrusion) fixedly connected to the movable part 10. Optionally the bearing arrangement comprises a rolling element 61 such as a ball bearing for rolling relative to the bearing surfaces.

Optionally, the bearing arrangement is a helical bearing. However, it is not essential for the bearing arrangement 60 to comprise a helical bearing. By providing engagement via the bearing arrangement 10, the lateral forces applied by the resilient element 51 may be reduced, or even eliminated. The lateral force element may be disengaged by use of the bearing arrangement 60. The bearing arrangement 60 may result in the only lateral forces being friction. Although FIG. 15 shows use of a rolling bearing, in an alternative arrangement the rolling bearing may be replaced by a sliding bearing (for example a plain bearing). Use of the bearing arrangement 60 helps to decouple the normal force of the resilient element 51 from the lateral forces. The normal forces desirable for transferring vertical loading of the helical bearing arrangement 20. The lateral component of the forces undesirable. The lateral component of the force is reduced by the bearing arrangement 60.

FIG. 16 is a schematic side view of an actuator assembly 1. The arrangement shown in FIG. 16 is similar to the arrangement shown in FIG. 15. However, the arrangement shown in FIG. 16 comprises a sliding bearing as the bearing arrangement 60 instead of a rolling bearing. The bearing arrangement 60 shown in FIG. 16 may have greater friction than the rolling bearing shown in FIG. 15. However, the amount of friction may depend on the materials and design of the bearing arrangement 60.

Although FIG. 15 and FIG. 16 show that the resilient element 51 may be fixedly connected to the support structure 2 and engaged with the movable part 10 via a bearing arrangement 60, this is not essential. In an alternative embodiment, the resilient element 51 may be fixedly connected to the movable part 10 and may engage with the support structure 2 via a bearing arrangement.

FIG. 17 is a schematic side view of an actuator assembly 1. As shown in FIG. 17, optionally the loading arrangement 50 comprises a magnetic loading arrangement. As shown in FIG. 17, optionally the magnetic loading arrangement comprises a magnet 65 and a magnetic material 66. In the arrangement shown in FIG. 17, there are two magnet 65 and two magnetic materials 66. The magnetic loading arrangement is configured to provide the force for loading the helical bearing arrangement 20. The number of magnets and magnetic materials is not particularly limited. In order to provide the loading torque 56, it is desirable to have at least two magnets and two magnetic materials 66. However, the number of magnets 65 may be four and the number of magnetic materials may be four, for example.

By providing the magnets 65, the loading torque 56 may be applied with little or even no lateral forces. The magnet 65 has a low lateral force over the stroke of the movable part 10. In particular, if the magnetic material 66 is provided such that it is wider than the magnet 65 in the direction perpendicular to the helical axis H, then the magnetic field shift may be expected to be not particularly significant over the stroke of movement of the movable part 10 along the helical axis H. The magnetic material 66 may be provided as a metal shim, for example.

### SMA Wire

The above-described actuator assembly 1 comprises actuator components. Optionally the actuator components are SMA elements, for example SMA wires. The term SMA wire may refer to any element comprising SMA. The SMA wire may have any shape that is suitable for the purposes described herein. The SMA wire may be elongate and may have a round cross section or any other shape cross section. The cross section may vary along the length of the SMA wire. It is also possible that the length of the SMA wire (however defined) may be similar to one or more of its other dimensions. The SMA wire may be pliant or, in other words, flexible. In some examples, when connected in a straight line between two elements, the SMA wire can apply only a tensile force which urges the two elements together. In other examples, the SMA wire may be bent around an element and can apply a force to the element as the SMA wire tends to straighten under tension. The SMA wire may be beam-like or rigid and may be able to apply different (e.g. non-tensile) forces to elements. The SMA wire may or may not include material(s) and/or component(s) that are not SMA. For example, the SMA wire may comprise a core of SMA and a coating of non-SMA material. Unless the context requires otherwise, the term ‘SMA wire’ may refer to any configuration of SMA wire acting as a single actuating element which, for example, can be individually controlled to produce a force on an element. For example, the SMA wire may comprise two or more portions of SMA wire that are arranged mechanically in parallel and/or in series. In some arrangements, the SMA wire may be part of a larger piece of SMA wire. Such a larger piece of SMA wire might comprise two or more parts that are individually controllable, thereby forming two or more SMA wires.

### Other Variations

It will be appreciated that there may be many other variations of the above-described examples.

For example, the actuator assembly 1 may comprise a mixture of sliding bearing and rolling bearings. As a further alternative the bearing arrangement may comprise a flexure arrangement.

1. An actuator assembly comprising:
a support structure;
a movable part;
a helical bearing arrangement arranged to guide helical movement of the movable part relative to the support structure around a helical axis;
a loading arrangement arranged between the support structure and the movable part for loading the helical bearing arrangement; and
at least one pair of actuator components arranged, on actuation, to drive rotation of the movable part in opposite senses around the helical axis which the helical bearing arrangement converts into said helical movement;
wherein the at least one pair of actuator components is arranged to apply an unloading torque about an axis perpendicular to the helical axis so as to reduce loading of the helical bearing arrangement.

2. An actuator assembly according to claim 1 wherein the loading arrangement is arranged to apply a loading torque about an axis perpendicular to the helical axis for loading the helical bearing arrangement.

3. An actuator assembly according to claim 1, wherein the at least one pair of actuator components are arranged to apply forces to the movable part relative to the support structure that are offset from each other along the helical axis.

4. An actuator assembly according to claim 1, wherein the at least one pair of actuator components are arranged to apply forces in opposite directions perpendicular to the helical axis such that the unloading torque can be applied without applying an overall force perpendicular to the helical axis.

5. An actuator assembly according to claim 1, wherein the helical bearing arrangement is arranged to have sufficient friction when loaded that the movable part remains in position when the actuator components are not driving rotation of the movable part.

6. An actuator assembly according to claim 5, wherein the helical bearing arrangement is arranged to have sufficient friction when loaded that the movable part, over a continuum of positions, remains in position when the actuator components are not driving rotation of the movable part.

7. An actuator assembly according to claim 1, wherein the loading arrangement is arranged to load the helical bearing arrangement so as to generate frictional forces therein that constrain the movement of the movable part relative to the support structure at any position within a range of movement when the actuator components are not actuated.

8. An actuator assembly according to claim 7, wherein the pair of actuator components is arranged, on actuation, to apply the unloading torque so as to reduce the frictional forces in the helical bearing arrangement.

9. An actuator assembly according to claim 1, wherein the helical bearing arrangement comprises at least one helical bearing that is a rolling bearing comprising bearing surfaces on the support structure and the moveable element and at least one rolling bearing element disposed between the bearing surfaces.

10. An actuator assembly according to any claim 1, wherein the helical bearing arrangement comprises at least one helical bearing that is a sliding bearing comprising bearing surfaces on the support structure and the moveable part arranged to slide against each other.

11. An actuator assembly according to claim 1, wherein the helical bearing arrangement comprises three helical bearings.

12. An actuator assembly according to claim 11, wherein the bearing surfaces of first and second helical bearings each comprises grooves on each of the support structure and the movable part, and the bearing surfaces of a third helical bearing comprises a groove on one of the support structure and the movable part and a planar surface on the other of the support structure and the movable part.

13. An actuator assembly according to claim 12, wherein the first, second and third helical bearings each comprise a single rolling bearing element only.

14. An actuator assembly according to claim 1, wherein the at least one pair of actuator components is arranged to reduce loading of the helical bearing arrangement by less than loading applied by loading arrangement.

15. An actuator assembly comprising:
a support structure;
a movable part;
a helical bearing arrangement arranged to guide helical movement of the movable part relative to the support structure around a helical axis;
at least one actuator component arranged, on contraction, to drive rotation of the movable part around the helical axis which the helical bearing arrangement converts into said helical movement; and
a loading arrangement arranged to apply a loading torque about an axis perpendicular to the helical axis for loading the helical bearing arrangement.

16. An actuator assembly according to claim 15, wherein the loading arrangement comprises a resilient loading arrangement for resiliently loading the helical bearing arrangement.

17. An actuator assembly according to claim 16, wherein the resilient loading arrangement comprises a pair of resilient elements connected between the support structure and the movable part.

18. An actuator assembly according to claim 16, wherein the resilient loading arrangement comprises at least one resilient element between the support structure and the movable part, the resilient element comprising at least a portion extending between the support structure and the movable part that is at least as thick in a direction parallel to the helical axis as in a direction perpendicular to the helical axis.

19. An actuator assembly according to claim 16, wherein the resilient loading arrangement comprises at least one resilient element between the support structure and the movable part, wherein the resilient element is stressed in its mounted position connected between the support structure and the movable part so as to load the helical bearing arrangement, whereby parts of the resilient element that engage with the support structure and the movable part are less distanced in a direction along the helical axis than if the resilient element were not stressed.

20. An actuator assembly according to claim 19, wherein the difference in how distanced along the helical axis the parts of the resilient element that engage with the support structure and the movable part are is greater than a possible range of movement of the movable part along the helical axis.

21. An actuator assembly according to claim 16, wherein the resilient loading arrangement comprises at least one resilient element between the support structure and the movable part, the resilient element being stiffer to bending around an axis perpendicular to the helical axis than to bending around the helical axis.

22. An actuator assembly according to claim 16, wherein the resilient loading arrangement comprises at least one resilient element that engages with at least one of the support structure and the movable part via a bearing arrangement.

23. An actuator assembly according to claim 1, wherein the loading arrangement comprises a magnetic loading arrangement.

24. An actuator assembly according to claim 1, wherein each actuator component is a shape memory alloy, SMA, element.

25. An actuator assembly according to claim 1, wherein the movable part is a lens element comprising at least one lens, wherein the helical axis is the optical axis of the lens element.

26. An actuator assembly according to claim 25, wherein the support structure has an image sensor mounted thereon, the lens element being arranged to focus an image on the image sensor.
